(19) United States
(12) Patent Application Publication
(10) Pub. No.: US 2015/0313411 A1
(43) Pub. Date: Nov. 5, 2015

(54) SECURE CONTAINER COVER

(71) Applicant: Rory Chesley Patrick Millikin, Kelowna (CA)

(72) Inventor: Rory Chesley Patrick Millikin, Kelowna (CA)

(21) Appl. No.: 14/267,523

(22) Filed: May 1, 2014

(51) Int. Cl. A47J 37/12; B65D 55/02; B65D 43/16; B65D 43/26; B65D 43/02; B65D 43/22

(52) U.S. Cl. CPC A47J 37/128; A47J 37/1219; B65D 43/02; B65D 43/22; B65D 43/16; B65D 43/26; B65D 55/02; B65D 2251/0021; B65D 2251/0081

(57) ABSTRACT

Systems, methods and apparatuses for making fryers safer and/or more energy efficient are disclosed. Methods and devices in accordance with the present disclosure generally comprise a cover, having a number of flaps, doors or plates that open to receive a basket or lower to submerge a basket. The cover can be maintained in a suitably rigid closed locked position, for example, by a locking mechanism, preventing the basket(s), body parts, or other items from unintentionally being placed in the fryer. In such embodiments, the cover also prevents the loss of heat from the oil. Alternatively, the cover may be maintained in a closed position, though not necessarily locked, with a primary purpose of preventing heat loss from the oil. In such embodiments, the cover may be vented.

### CROSS-REFERENCE(S) TO RELATED APPLICATION(S)

This non-provisional application is related to U.S. provisional patent application No. 61/818,302 filed on 1 May 2013, and to U.S. provisional patent application No. 61/889,854 filed on 13 Oct. 2013, the disclosures of which are hereby expressly incorporated by reference in their entirety, and the benefit of the priority dates of which is hereby claimed under 35 U.S.C. §119(e).

### TECHNICAL FIELD

This application relates generally to containers and more particularly, to a cover for cooking and other containers.

### BRIEF DESCRIPTION OF THE DRAWINGS

The drawings, when considered in connection with the following description, are presented for the purpose of facilitating an understanding of the subject matter sought to be protected.

FIG. 1 is an isometric view of an example fryer with a vented cover with one bay in a closed position and another in an open position with a fryer basket therein in accordance with the present disclosure;

FIG. 2 is an isometric view of an example independent cover with one bay in a closed position and another in a semi-open position in accordance with the present disclosure;

FIG. 3 is a rear isometric view of an example independent cover with one bay in a closed position and another bay in an open position in accordance with the present disclosure;

FIG. 4 is an isometric view of an example independent vented cover with one bay in a closed position and another in an open position in accordance with the present disclosure; and

FIG. 5 is an isometric view of an example independent cover configured to open a container by a translating motion of the cover;

FIG. 6 is an isometric view of an example independent set of flaps configured to be removable and replaceable.

### DETAILED DESCRIPTION

While the present disclosure is described with reference to several illustrative embodiments, it should be clear that the present disclosure is not limited to such embodiments. Therefore, the description of the embodiments provided herein is illustrative of the present disclosure and should not limit the scope of the disclosure as claimed. In addition, while the following description references an oil fryer such as those for Onion Ring and French Fries, it will be appreciated that the disclosure may include other types of food fryers, and containers in general.

A popular method of cooking is to fry or deep fry many food items. A brief list of foods that may be deep fried include various vegetables, french fries, potato chips, chicken, pork, beef, candy bars, ice cream, etc. Many other types of food are amenable to deep frying. Deep frying generally involves immersing the food item in a high-temperature fat-based solution, such as in cooking oil (e.g., canola oil, peanut oil, vegetable oil, olive oil, liquefied shortening, etc.) until the food is cooked, though other liquids such as water or even air can be used.

While fried foods and the fryers used to cook the fired foods are popular, the temperatures found in the frying liquids are quite high, often greater than 300 degrees Fahrenheit. Thus, body parts being accidentally submerged in hot fryer oil or items (e.g., common kitchen items such as spice shakers, utensils, aerosol cans, etc.) falling into hot oil is a dangerous possibility. Apart from safety, open fryer vessels unnecessarily allow heat to escape into air requiring frequent input of energy to maintain and/or bring oil temperatures to cooking temperature. Many fryers and/or containers do not have covers because it is not convenient for a user to frequently remove and replace the fryer and/or container cover. Thus, a system that prevents energy loss and helps avoid body parts and other items from contacting or falling into oil is desirable.

As set forth in the detailed description, in accordance with various embodiments of the present disclosure systems, methods and apparatuses for making fryers safer and/or more energy efficient are provided. With reference to the figures attached hereto, methods and devices in accordance with the present invention generally comprise a cover, having a number of flaps, doors, or plates that cover a cooking chamber containing a hot liquid, which may be opened to receive a basket or that may be lowered to submerse a basket into the chamber. These flaps, doors, or plates may or may not be hinged. The cover or a part of the cover can be maintained in an open or closed position. The closed part(s) of the cover may be also locked, for example, by a locking mechanism, preventing the basket(s), body parts, or other items from unintentionally being placed in the fryer chamber, thus increasing the safety. In such embodiments, the cover also prevents the loss of heat from the oil, thus increasing the energy efficiency. Alternatively, the cover can be maintained in a closed position, though not necessarily locked, with a primary purpose of preventing the loss of heat from the oil. In such embodiments, the cover may be vented.

In addition to safety and efficiency, another advantage of the present disclosure is the easy and cost effective retrofitting of the existing kitchens and cooking apparatus. The following disclosed embodiments may be described in terms of functional components and/or various processing steps. Each functional component may include any number of parts configured to perform specified functions and achieve various results. Those skilled in art will recognize that the disclosed apparatus and/or method are not limited to food preparation and may be used for controlling access to any container.

The detailed description herein makes use of various exemplary embodiments to assist in disclosing the present invention. While these exemplary embodiments are described in sufficient detail to enable those skilled in the art to practice the invention, it should be understood that other embodiments may be realized and that different combinations and modifications of structures, arrangements, applications, proportions, elements, materials, or components used in the practice of the present disclosure, in addition to those not specifically recited, can be varied or otherwise particularly adapted to specific environments, manufacturing specifications, design parameters or other operating requirements without departing from the scope of the present disclosure and are intended to be included in this disclosure. Thus, the detailed description herein is presented for purposes of illustration only and not of limitation.

In accordance with an exemplary embodiment of the present disclosure, the system, methods, and devices disclosed herein discuss frying foods and the safety and efficiency considerations related thereto. The terms “cooking” and “frying” and formatives thereof may be used interchangeably herein. Other mechanisms and devices for cooking food besides frying fall within the scope of the present disclosure, such as boiling, blanching, steaming, poaching, simmering, steeping, and the like. For consistency, “frying” will be used throughout without limiting the methods of cooking for use in conjunction with embodiments of the present disclosure.

Additionally, in certain embodiments water may be used in place of cooking oil in order to boil, poach, blanch or otherwise cook certain foods. The foods are housed within the basket and cooked in the heated water in a water chamber, where the water chamber takes the place of the oil chamber. Such foods that may be cooked by this process comprise pasta products and vegetables.

Examples of heating mechanisms used in connection with maintaining and regulating the temperature of the oil in accordance with the present disclosure include, but are not limited to, various gas and electric heating elements, as well as other now known or as yet unknown heating mechanism suitable for heating oil.

According to various exemplary embodiments of the present invention, devices used herein are available in numerous sizes and/or capacities. For example, the device may be available in commercial sizes for use by restaurants and other food-frying establishments and large food manufacturers and producers that must produce hundreds, if not thousands, of pounds of fried food every day. Commercial devices may range in size depending on the desired capacity for the device. Other embodiments of the invention provide a device that is amenable to use by smaller businesses and food stands, or even in a user's home. For example, devices in accordance with the present invention may be configured to be easily “retrofit” to existing kitchen cooking devices and appliances. Those skilled in the art will appreciate that various embodiments of the present invention can comprise floor model, ventless countertop models, pressure fryer models, and home models.

Moreover, such a device for personal use may produce as little as one serving of food and may be configured to be placed on a countertop. The materials used for the various components described herein may be various heat resistant materials, such as high temperature plastics, ceramics, metals, and the like that will not be detrimentally effected by the temperature of the oil and heating elements described herein. All sizes and capacities of devices discussed are contemplated within the scope of the present invention.

Additionally, devices in accordance with the present disclosure can include any number of safety features, for example, fire suppression systems such as those using Ansul® fire suppression systems. In such embodiments, the devices can be configured with access openings so that the fire suppression systems are capable of injecting any extinguishing agent into the device and/or at the source of any fire. In some embodiments, the device may be sufficiently sealed to extinguish any outbreak of fire within the cooking chamber. In other embodiments, there may be a combination of sealing and extinguishing agents used to suppress any fires.

Devices in accordance with the present disclosure are generally readily cleanable. For example, in some embodiments the various components, such as the covers disclosed herein, are removable or hinged to facilitate ease of cleaning. For example, the cover may be rotatable on a hinge to provide access to locations that are otherwise difficult to reach and clean. In other embodiments, components such as the flaps, plates, locking mechanisms, etc. described herein may be removable to facilitate cleaning.

The baskets of the various embodiments disclosed herein may be of any shape or size (e.g., circular, square, rectangular or otherwise). This deposit may occur in any suitable way. For example, food may simply be deposited manually by an operator into the basket. Alternatively, the depositing of the food may be automated, for example via robotic/mechanical arms, conveyors and transport mechanisms which transport the food. In various embodiments, baskets in accordance with the present invention may be designed for specific food types, such as baskets with vertical basket slots for “planar” foods (e.g., hash brown patties, chicken patties, etc.). For example, for hash brown patties, it may be desirable to keep the patties upright.

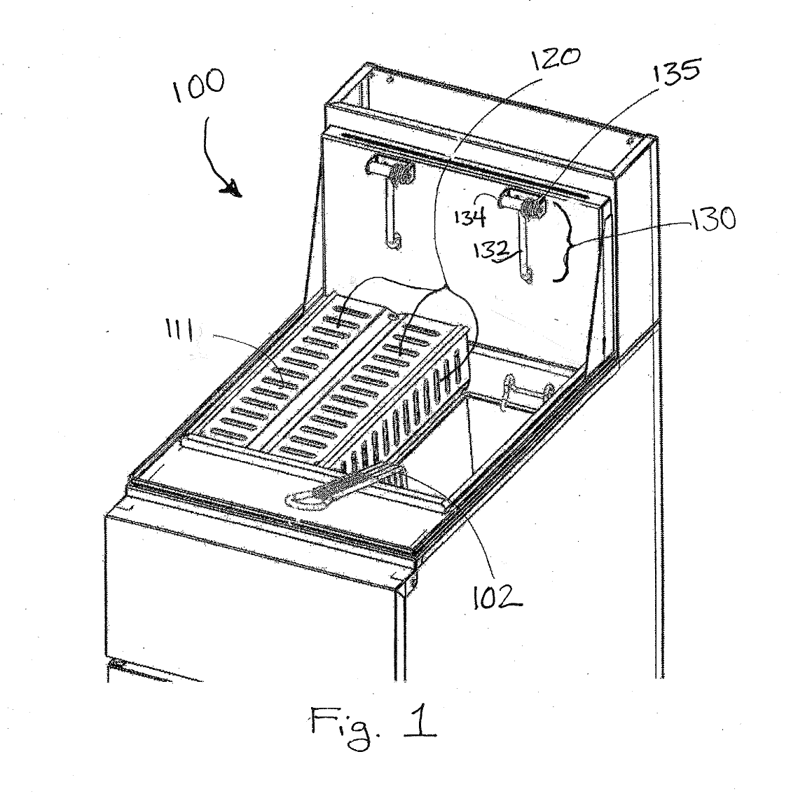

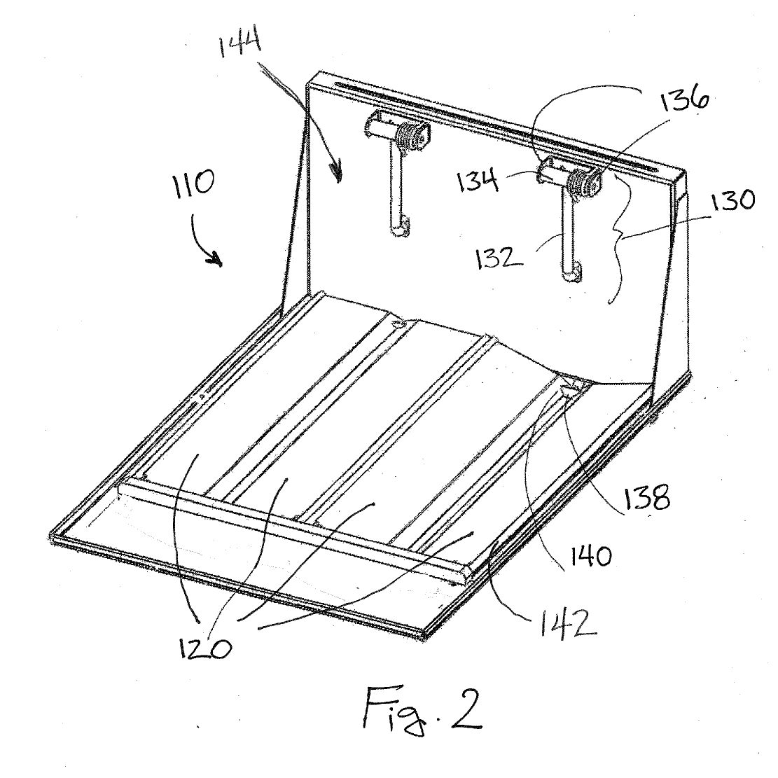

As will be discussed in more detail below, FIG. 1 illustrates a fryer 100 with an integrated cover 110, and FIG. 2 illustrates a replaceable fryer cover 110, in accordance with the present disclosure. In the embodiment of FIG. 1, the fryer 100 has a cover 110, having a number of flaps/doors 120 that open to receive a basket 102 and that can move from a first position to a second position to receive the basket 102. The cover 110 and/or flaps 120 may comprise any suitable sub-system or device for selectively moving between the first and the second positions. In some embodiments, the cover may include perpendicular surfaces creating a partial box for covering the top of the cooking chamber. The perpendicular surfaces may include horizontally oriented surfaces constituting the flaps and vertically oriented surfaces supporting locking mechanisms and/or holding the flaps in place, the orientations being with respect to the fryer's operational position. The flaps 120 can be maintained in a suitably closed and locked position, for example, by a locking mechanism 130, preventing the basket(s) 102, body parts, or other items from unintentionally falling into the fryer 100, thus increasing safety. In such embodiments, the flaps 120 also prevent the loss of heat from the oil, and thus increasing the energy efficiency. In some embodiments, the covers may include additional layers of insulation to further reduce heat loss. Alternatively, the flaps 120 can be maintained in a closed position, though not necessarily locked, with a primary purpose of preventing the loss of heat from the oil. There may also exist a gap between the flaps 120, sufficient to allow cooking liquid that drips from the cooked food to pass back into the fryer 100. In the embodiment shown in FIG. 1, flaps/doors 120 have venting openings/slots 111. In the embodiment shown in FIG. 2, flaps/doors 120 do not have venting openings/slots and are solid.

In accordance with various embodiments, the flaps 120 of covers 110 can be maintained in a closed position, an open position, or in other positions. In embodiments where the flaps 120 are maintained in a closed position, they can be locked so they can withstand significant weight/pressure placed over them. In such embodiments, the flaps 120 are locked by the locking mechanism 130 which may be selectively released by the user. For example, the locking mechanism 130 may have a trigger that must be activated (e.g., push, rotated, lifted, etc.) by the user or by a device used by the user. In various embodiments, the flaps 120 and/or locking mechanism 130 may be biased, for example, by one or more springs, motors, or other mechanisms to return the flaps 120 to a closed position upon removal of a basket 102, at which point the lock bar 138 of the locking mechanism 130 re-engages the flaps 120 to maintain them in a locked position. The release mechanism of flaps 120 may include various photo-sensors, infrared sensors, RF sensors, and the like. Alternatively, the doors may be controlled by an operator or an automated process that signals and controls when the doors should open.

The above being noted, the flaps 120 of the cover 110 may be opened to allow the cooking chamber or interior of the fryer 100 to be accessed for cooking the food. The various covers 110 described herein may further provide heat retention benefits by preventing the escape of heat within the device. As noted above, the covers 110 may also be configured with various seals to provide insulation/heat retention and pressurization capabilities, as well as other benefits such as sound dampening.

In various alternative embodiments, such as the embodiment shown in FIG. 2, the cover 110 may be independent from the rest of the fryer 100 to allow retro-fitting the cover 110 to existing fryer devices. Advantages of such retrofit configurations are cost savings by virtue of using existing fryer devices, yet providing the capability to realize the safety and/or efficiency objectives described herein.

In the embodiments of FIGS. 1 and 2, for example, the cover 110 has four flaps 120 that open downwardly to receive a basket 102. The flaps 120 can be maintained in a suitably rigid closed locked position, such as by a locking mechanism 130, preventing the basket(s) 102, body parts, or other items from unintentionally dropping in the fryer 100, therefore, increasing safety. In such embodiments, the flaps 120 also prevent the loss of heat from the oil, thus, increasing efficiency. Alternatively, the flaps 120 can be maintained in a closed position, though not necessarily locked with a primary purpose of preventing the loss of heat from the oil. In some embodiments, such as in FIG. 1, the flaps 120 of cover 110 are vented. In various embodiments the horizontal surface of cover 110 may include multiple sections, some with and some without flaps 120. Such embodiments will fulfil the needs of those who may not want to cover their entire fryer with flaps. In other embodiments the flaps 120 may be added to the cover 110, as needed.

In accordance with various embodiments, the flaps 120 of covers 110 as disclosed herein can be maintained in a closed position, an open position, or somewhere in between. In embodiments where the flaps 120 are maintained in a closed position, they can be locked to withstand significant pressure such as a downward force of a hand or a foot. In such embodiments, the flaps 120 are locked by a locking mechanism 130 which is only released when affirmatively desired by the user. For example, the locking mechanism 130 may have a trigger that must be actuated (e.g., push, rotated, lifted, etc.) by the user or by a device used by the user.

In an embodiment such as shown in FIG. 1, the basket 102 is used to release the locking mechanism 130, by pressing the basket 102 against a push bar 132, which causes the locking mechanism 130 to pivot on a pivot tube 134 held by a pivot bar bracket 136, causing a lock bar 138 to disengage from the flaps 120, which had previously been retained by a slot 140 in the flaps 120, allowing the flaps 120 to open by rotating around a hinge/flap rod 142 and the basket 102 to be placed in the cooking liquid. As seen in various figures of various embodiments, the basket(s) 102 of food is lowered into oil as would be done in a conventional fryer. In various embodiments, the flaps 120 and/or locking mechanism 130 may be biased, for example, by one or more springs, motors or other mechanisms to return the flaps 120 to a closed position upon removal of the basket 102, at which point the lock bar 138 re-engages with the flaps 120 to maintain them in a locked position. In some embodiments in which the flaps 120 are spring loaded to come back to the closed position upon removal of basket(s) 102. In other embodiments the flaps 120 may drop down under their weight once they are unlocked.

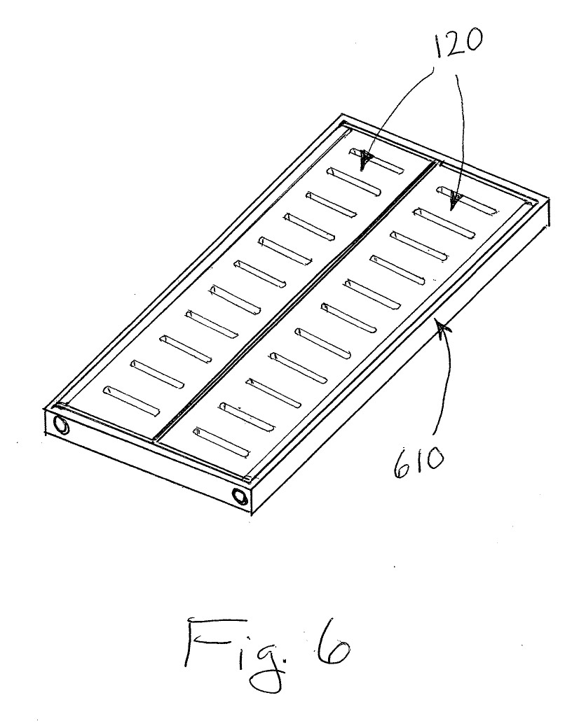

In various embodiments flaps 120 may open upwardly or downwardly with respect to the opening of the cooking chamber. In some embodiments flaps 120 may be closed even after a basket 102 is lowered into the cooking liquid and may be kept closed while the food inside the basket 102 is being cooked. In different embodiments flaps 120 may be an integral part of cover 110 or may be easily removable and/or replaceable. In such embodiments the horizontal surface of the cover 110 may be kept totally or partially covered by flaps 120, as desired. FIG. 6 illustrates an example set of replaceable/removable flaps 120 within frame 610, which can easily be removed from cover 110 for any reason, such as for cleaning, and replaced when desired.

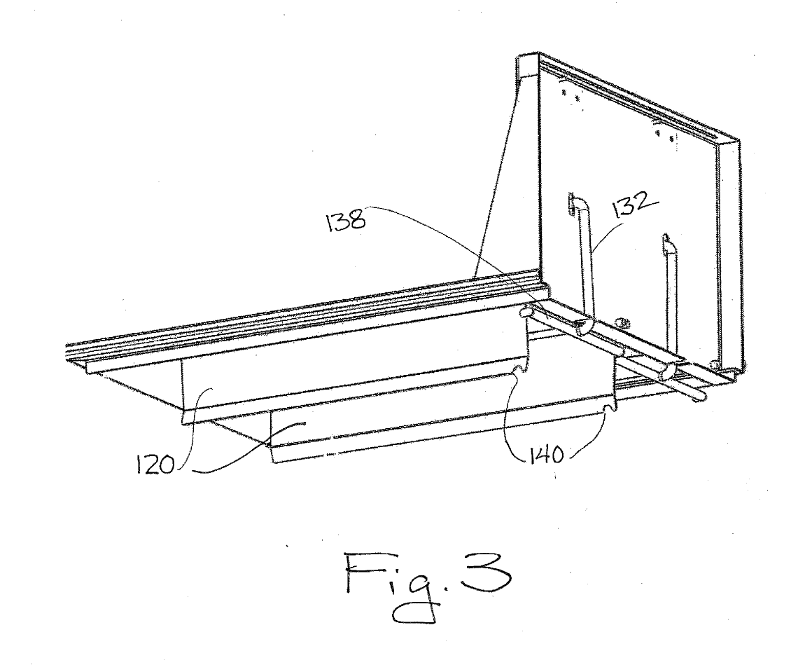

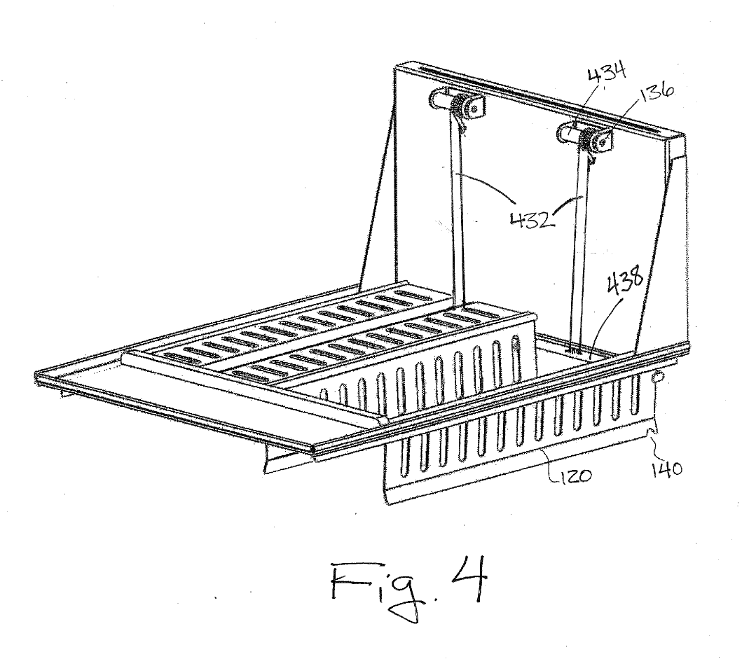

In the embodiments shown in FIGS. 1-3, the push bar 132 has an “S” shape. In these embodiments one part of the push bar 132 is on the front side of the face-plate 144 and the other part of the push bar 132, as shown in FIG. 3, is located on the back side of the face-plate 144. In various embodiments, such as in FIG. 4, the push bar 432, from its connection to the pivot tube 434 all the way to the lock bar 438, may be on one side of the face-plate 144; either the front side or the back side of the face-plate 144. In embodiments in which the push bar 432 is at the back side of the face-plate 144, a push-rod may be passed through a hole in the face-plate 144 such that one end of the push-rod is attached to the push bar 432, at the back of face-plate 144, and the other end of the push-rod is accessible at the front side of the face-plate 144. With such an exemplary arrangement pushing the push-rod will in turn push the push bar 432 which will unlock the flaps 120. Other release mechanisms can include various photo-sensors, infrared sensors, RF sensors, and the like. Alternatively, the doors may be controlled by an operator or an automated process that signals and controls when the doors should open or close.

In some embodiments, with reference to FIGS. 1 and 4, the push bar 132 or 432 may be actuated single-handedly using the fryer basket edge or handle. This way, a user may fill the basket 102 with the desired food and, with one hand, push the basket's front edge or handle into the push bar 132/432 while at the same time lowering the basket into the cooking chamber. When the push bar is pushed, the lock on the covers is released allowing the weight of the basket to further push down the covers to open the cooking chamber.

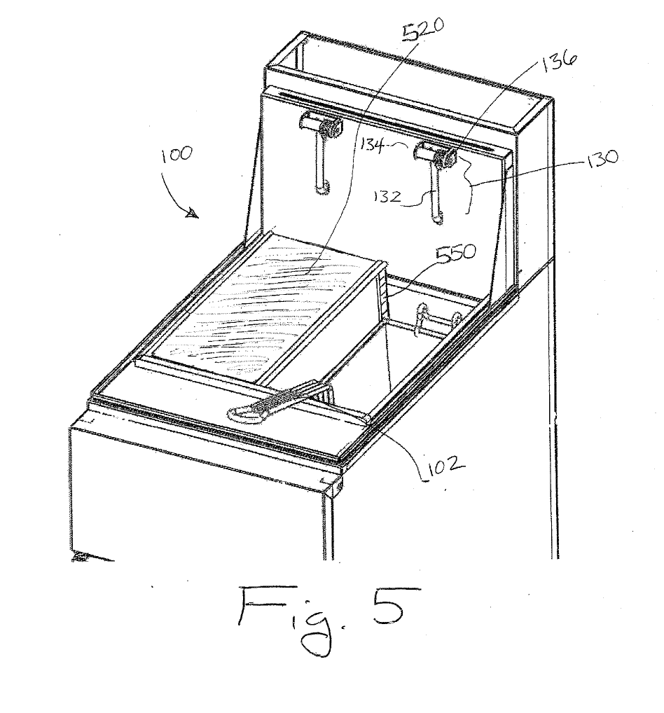

In various alternative embodiments, such as the one shown in FIG. 5, flaps 120 which are hinged in other embodiments, are replaced by horizontal lifting plates 520 which move up and down on tracks 550 while keeping their horizontal orientation. In such embodiments basket(s) 102 may be placed on the lifting plates 520 to be lowered into the cooking liquid or to be raised out of the cooking liquid. When in the raised position, the lifting plates 520 will act as a cover providing the safety and/or efficiency benefits described above. To cook food, the basket 102 is placed on or attached to a lifting plate 520, and the plate is lowered into the cooking liquid. The lifting plates 520 may be moved on or by any mechanism which controls their travel into the liquid, for example, on a vertical track 550, or other “elevator” type mechanisms. In those embodiments with lifting plates 520, a locking mechanism 130 may still lock and unlock the lifting plates 520 in their up-position. In various embodiments the cover 110 may have both flaps 120 and plates 520, side by side and/or together. In the embodiments in which flaps 120 and plates 520 are employed together, plates 520 may be under flaps 120, while flaps 120 opens upwardly and plates 520 are used as an up-down elevator for food or food basket 102. In such embodiments flaps 120 may be closed, after plate 520 travels down into the cooking liquid, and may remain closed until the food is cooked.

While the locking mechanism 130 is hinged on one side in all described embodiments, it is known to those skilled in the art that a non-hinged locking mechanism may be also used in place of the locking mechanism 130. For example an electrical push-button on the surface of the face-plate 144 may activate a solenoid that in turn engages or disengages a lock bar 138 with the flaps 120 or lifting plates 520 in their open and/or closed positions.

In various embodiments such as any of those described herein, the basket(s) 102 may be raised, lowered, rotated, and/or translated by a mechanical device operated manually by a user, for example, by raising a handle which is attached to the basket or basket platform. Other mechanisms may likewise be manually operated. For example, by turning a crank the basket may be raised, and if needed, translated to a dumping position, where it engages a lip or other section of the device, proximate an exit chute, which causes the basket to rotate or pivot and allow the food to be ejected through the chute.

Additionally, as mentioned above, in various embodiments, various parameters of the present invention may be automated with one or more controllers. For example, a controller may regulate, among other aspects, the amount of time for cooking, movement of the basket(s), movement of foods from one section to another, or the like, all according to pre-programmed settings or from input from a user, for example through a key pad or various buttons, dials or switches. Controller may comprise any type of controller known in the art for controlling electrical and/or mechanical systems (e.g., printed circuit boards and the like). As a motor controller, controller may direct the operation of a motor to move/agitate and/or move the basket. In other embodiments, controller accepts input from a user for temperature, time, tilt angle, depth of travel, and other parameters a user would want to control in relation to the operation of the device. In further embodiments, controller may control automatic extraction of the food from device when the cooking process is complete.

In various embodiments and as shown in the various figures attached hereto, a plurality of baskets may be provided within device in various configurations (e.g., side-by-side, stacked, etc.). By providing multiple baskets, different foods can be kept segregated from others allowing for individual parameters relating to the processing to be controlled (e.g., keeping fish separate from French Fries). Additionally, larger total batches may facilitated.

Finally, various principles of the present invention have been described in exemplary embodiments. However, many combinations and modifications of the above-described structures, arrangements, proportions, elements, materials, and components, used in the practice of the invention, in addition to those not specifically described, can be varied without departing from those principles. Various embodiments have been described as comprising automatic processes, but these processes may be performed manually without departing from the scope of the present invention.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A food cooking system comprising:
a container for holding cooking liquid;
a basket for holding food;
a cover situated on top of the container, having at least a rotating hinged flap that is configured to be opened and closed and/or a translating lifting plate that is configured to be lowered and raised, and having a locking device configured to lock the hinged flap in a closed position and/or the lifting plate in an up position; and
wherein opening the hinged flap and/or lowering the lifting plate allows the basket to be submerged in and retrieved from the cooking liquid.

2. The food cooking system of claim 1, wherein the container is retrofitted with the cover.

3. The food cooking system of claim 1, wherein the cover is integrated with the container.

4. The food cooking system of claim 1, further comprising two or more baskets.

5. The food cooking system of claim 1, wherein the locking device is mechanically or electrically activated.

6. The food cooking system of claim 1, wherein the at least one flap or plate further comprises a venting slot.

7. The food cooking system of claim 1, wherein the at least one flap or plate is biased closed.

8. The food cooking system of claim 1, wherein the at least one flap or plate is biased closed by at least a spring or a motor.

9. The food cooking system of claim 1, wherein the locking device is mechanical and comprises a hinge, a push bar, and a locking bar.

10. The food cooking system of claim 1, wherein the locking device unlocks the flap or the plate by triggering a sensor.

11. The food cooking system of claim 1, wherein cooking system is automated.

12. A cover for liquid based cooking devices, the cover comprising:
a substantially vertical surface;
a substantially horizontal surface;
at least a rotating hinged flap on the horizontal surface of the cover that is configured to be opened and closed and/or a translating lifting plate on the horizontal surface of the cover that is configured to be lowered and raised, to allow or to prevent passage of an object from one side of the horizontal surface to the other side of the horizontal surface of the cover;
a locking device configured to lock the hinged flap in a closed position and/or the lifting plate in an up position, wherein the locking device is activated from over the vertical surface of the cover; and
wherein opening the hinged flap and/or lowering the lifting plate allows a food item or a food basket to be submerged in and retrieved from a cooking liquid of the cooking device.

13. The cover of claim 12, wherein the flap or plate is mechanically or electrically activated.

14. The cover of claim 12, wherein the flap or the plate further comprises a venting slot.

15. The cover of claim 12, wherein the flap or the plate is biased closed.

16. The cover of claim 12, wherein the flap or the plate is biased closed by at least a spring or a motor.

17. The cover of claim 12, wherein the locking device is mechanical and comprises a hinge, a push bar, and a locking bar.

18. The cover of claim 12, wherein the locking device unlocks the flap or the plate by triggering a sensor.

19. The cover of claim 12, wherein the flap is closed before and after the food item or the basket is submerged in the cooking liquid of the cooking device.

20. A cover for a container, the cover comprising:
a substantially vertical surface;
a substantially horizontal surface;
at least a rotating hinged flap on the horizontal surface of the cover that is configured to be opened and closed and/or a translating lifting plate on the horizontal surface of the cover that is configured to be lowered and raised; and
a locking device configured to lock the hinged flap in a closed position and/or the lifting plate in an up position, wherein the locking device is activated from over the vertical surface of the cover, wherein opening the hinged flap or the lifting plate allows an item or liquid to be put into and/or taken from the container.
